(19) United States
(12) Patent Application Publication
(10) Pub. No.: US 2009/0327363 A1
(43) Pub. Date: Dec. 31, 2009

(54) SYSTEMS AND METHODS FOR PROCESSING ELECTRONICALLY TRANSMITTED HEALTHCARE RELATED TRANSACTIONS

(76) Inventors: Peter Cullen, Atlanta, GA (US); Elizabeth S. Kaye, Suwanee, GA (US)

Correspondence Address: SUTHERLAND ASBILL & BRENNAN LLP, 999 PEACHTREE STREET, N.E., ATLANTA, GA, 30309, US

(21) Appl. No.: 12/418,829

(22) Filed: Apr. 6, 2009

Related U.S. Application Data
(60) Provisional application No. 61/077,019, filed on Jun. 30, 2008.

(51) Int. Cl. G06F 17/30; G06Q 50/00; G06F 15/16

(52) U.S. Cl. 707/204; 705/3; 705/2; 709/206; 707/E17.044; 707/E17.005

(57) ABSTRACT

Systems and methods for the processing, modifying, and/or performance of a clinical, administrative and/or financial “value-add” service to an electronic healthcare related transaction from a healthcare provider to a third party such as a pharmacy. A prescription switch provider receives an incoming transaction from a healthcare provider system. The switch provider may then parse the transaction to review or modify data contained in the transaction and/or perform a value-add service or function based on the data contained in the transaction. Alternatively, the switch provider may copy the transaction for parallel processing. The transaction may be forwarded to a third party system, and a response message from the switch provider or the third party may be transmitted to the healthcare provider system pertaining to the modified transaction data and/or value-add service performed.

### CROSS REFERENCE TO RELATED APPLICATION

This application claims the benefit of priority to U.S. Provisional Application No. 61/077,019, filed Jun. 30, 2008, entitled “Systems and Methods for Processing Electronically Transmitted Healthcare Related Transactions,” which is hereby incorporated by reference as if set forth fully herein.

### FIELD OF THE INVENTION

Aspects of the invention relate generally to healthcare related transactions, and more particularly, to systems and methods for processing electronically transmitted healthcare related transactions.

### BACKGROUND OF THE INVENTION

In current medical insurance claims transactions there is a bi-directional information flow between pharmacies and insurance claim payors that includes an intermediary processor that provides “pre” and/or “post” edit services relating to the routed claims. These “pre” and/or “post” edit services verify the content of an electronically transmitted insurance claim, such as a healthcare insurance claim, by intercepting the claim, reviewing the claim's contents, and comparing the claim to pre-established claim criteria established either by the insurance provider (or payer) or both a healthcare service provider and insurance provider. If the claim contains the appropriate content the claim is forwarded to its intended recipient, typically a payer such as an insurance company or government healthcare payer; otherwise the claim may be returned to the sender with an indication that corrective action may be necessary. Alternatively, the claim may be edited by the intermediary processor and then forwarded to its intended recipient.

However, insurance claim editing processes occur separate from the healthcare service corresponding to the insurance claim and typically after the corresponding healthcare service has been completed or delivered. Thus, these insurance claim processing systems are unable to offer a variety of “value-add” services for the healthcare service corresponding to the insurance claim particularly before or while that healthcare service is being provided.

Recently, more and more healthcare services that traditionally have been provided manually are now transitioning to being provided electronically, such as drug prescription processing. Many healthcare providers' offices are being updated with electronic prescription software to create and electronically transmit prescriptions to a pharmacy for fulfillment. While such electronic prescription generation software does have some general data scrubbing capabilities embedded in the software, no independent review of the generated electronic prescription transaction is conducted before (or during) the routing of the electronic prescription transaction to the pharmacy. Thus, in electronic healthcare related transactions (e.g., electronic prescription transactions, etc.), there is a need to provide clinical, administrative and/or financial value-add services to the healthcare service being provided, as well as provide clinical, administrative and/or financial messages related to the healthcare related transaction processing to healthcare providers, patients, pharmacists, and/or the like.

### BRIEF DESCRIPTION OF THE INVENTION

According to an embodiment of the invention, there is disclosed a method for processing an electronic prescription transaction that includes receiving an electronic prescription transaction from a healthcare provider system, and performing, by a switch provider processor, a value-add service to the electronic prescription transaction, wherein the value-add service creates a modified electronic prescription transaction. The method further includes forwarding the modified electronic prescription transaction to a pharmacy system specified in the electronic prescription transaction.

In accordance with one aspect of the invention, the method further includes creating a copy of the electronic prescription transaction prior to creating a modified electronic prescription transaction, and storing the copy of the electronic prescription transaction. According to another aspect of the invention, the method further includes transmitting a response message to the healthcare provider system, where the response message is associated with the modified healthcare related transaction. In accordance with yet another aspect of the invention, the method further includes receiving an approval message from the healthcare provider system prior to forwarding the modified electronic prescription transaction to the pharmacy system.

According to another aspect of the invention, the method further includes storing the modified electronic prescription transaction prior to forwarding the modified electronic prescription transaction to the pharmacy system. In accordance with yet another aspect of the invention, the creation of a modified electronic prescription transaction includes correcting an error detected in the electronic prescription transaction. According to another aspect of the invention, the creation of a modified electronic prescription transaction includes amending the data contained in the electronic prescription transaction with routing information associated with the pharmacy system, where the pharmacy system is a preferred pharmacy system. In accordance with yet another aspect of the invention, the creation of a modified electronic prescription transaction includes amending the data contained in the electronic prescription transaction to include additional information pertaining to a prescribed drug identified in the electronic prescription transaction.

In accordance with another embodiment of the invention, there is a system for processing an electronic prescription transaction that includes a memory device, and a processor in communication with the memory device, wherein the processor is configured to execute computer executable instructions to receive an electronic prescription transaction from a healthcare provider system, perform a value-add service to the electronic prescription transaction, wherein the value-add service creates a modified electronic prescription transaction, and forward the modified electronic prescription transaction to a pharmacy system specified in the electronic prescription transaction.

According to one aspect of the invention, the processor is further configured to execute instructions to create a copy of the electronic prescription transaction prior to creating a modified electronic prescription transaction, and store the copy of the electronic prescription transaction in the memory device. In accordance with another aspect of the invention, the processor is further configured to execute instructions to transmit a response message to the healthcare provider system, where the response message is associated with the modified healthcare related transaction. According to yet another aspect of the invention, the processor is further configured to execute instructions to receive an approval message from the healthcare provider system prior to forwarding the modified electronic prescription transaction to the pharmacy system.

In accordance with another aspect of the invention, the processor is further configured to execute instructions to store the modified electronic prescription transaction prior to forwarding the modified electronic prescription transaction to the pharmacy system. According to yet another aspect of the invention, the computer executable instructions to create a modified electronic prescription transaction include correcting an error detected in the electronic prescription transaction. In accordance with another aspect of the invention, the computer executable instructions to create a modified electronic prescription transaction include amending the data contained in the electronic prescription transaction with routing information associated with the pharmacy system, where the pharmacy system is a preferred pharmacy system. According to yet another aspect of the invention, the computer executable instructions to create a modified electronic prescription transaction include amending the data contained in the electronic prescription transaction to include additional information pertaining to a prescribed drug identified in the electronic prescription transaction.

According to another embodiment of the invention, there is a system for processing a response to an electronic prescription transaction that includes a memory device, and a processor in communication with the memory device, where the processor is configured to execute computer executable instructions to receive, from a pharmacy system, a response to an electronic prescription transaction previously submitted by a healthcare provider system, perform a value-add service to the response to the electronic prescription transaction, wherein the value-add service creates a modified response, and forward the modified response to the healthcare provider system specified in the electronic prescription transaction. In accordance with one aspect of the invention, the processor is further configured to execute instructions to store the response in the memory device prior to creating a modified response. According to another aspect of the invention, the computer executable instructions to create a modified response include amending the response to include additional information. In accordance with yet another aspect of the invention, the additional information amended to the response is a disease management enrollment message.

### BRIEF DESCRIPTION OF THE FIGURES

FIG. 1 shows a healthcare related transaction system for the routing of electronic healthcare related transactions in accordance with an example embodiment of the invention.

FIG. 2 shows a data flow of the data transmitted between the entities of the healthcare related transaction system in accordance with an example embodiment of the invention.

FIG. 3 shows a flowchart for “pre” and “post” edit (PPE) processing of electronic healthcare related transactions in accordance with an example embodiment of the invention.

### DETAILED DESCRIPTION OF EMBODIMENTS OF THE INVENTION

Embodiments of the invention are directed to systems and methods for the processing, modifying, and/or performance of a clinical, administrative and/or financial value-add service to one or more healthcare related transactions. The term “healthcare related transaction” refers to data transmitted between a healthcare provider and a third party entity providing or assisting in providing a healthcare service to a healthcare provider and/or patient. Examples of healthcare related transactions may include electronic prescription transactions (also referred to as “e-scripts”) from a healthcare provider (e.g., physician) to a pharmacy such that the electronic prescription transactions informs the pharmacy of a prescription for the patient).

The term “value-add service” or “value-add services” refers to automated processing and/or amending of one or more healthcare related transactions to provide a healthcare service to a healthcare provider and/or patient associated with the healthcare related transaction. Examples of value-add services may include verifying that the dosage indicated in an electronic script submitted to a pharmacy from the healthcare provider's office is acceptable, providing healthcare provider offices with printable items associated with electronic prescription transactions and/or electronic patient eligibility transactions (e.g., vouchers for prescription drug samples or coupons for prescription and/or over the counter drugs that may be provided to patients at the healthcare provider's office for later redemption at a pharmacy, etc.), providing Medication Therapy Management (MTM) information, prescription refill information, etc. to a patient or physician. Other value-add services may also be implemented through example embodiments of the invention discussed in further detail below.

According to example embodiments of the invention, a switch provider receives an incoming healthcare related transaction from a healthcare provider's (e.g., physician, hospital, clinic, lab, pharmacist, etc.) system such as a practice management system. In other embodiments of the invention, other healthcare related transactions (e.g., service eligibility inquiries, etc.) may be processed in a way that is similar to the embodiments described herein with reference to electronic prescription transactions. In example embodiments of the invention, the transaction standard for the electronic healthcare related transactions (e.g., prescription submissions, eligibility inquiries, responses to eligibility inquiries, such as 270/271 eligibility messaging, and/or the like, etc.) may be one of National Council for Prescription Drug Programs (NCPDP) SCRIPT standard, American National Standards Institute (ANSI) X12, Health Level Seven (HL7), or similar transaction standards. Alternatively, the electronic healthcare related transactions and/or the format of the transactions may be proprietary. In an example embodiment of the invention, the electronic healthcare related transactions may specify a drug item, patient identification information, Bank Identification Number (BIN), group number, other prescription related information, etc. In another embodiment of the invention, the electronic healthcare related transactions such as electronic prescription transactions (also referred to as electronic “scripts”) may be issued both electronically and manually to allow a variety of ways for the prescription related information to be provided to the pharmacy and/or allow the patient to have a physical record of the transaction.

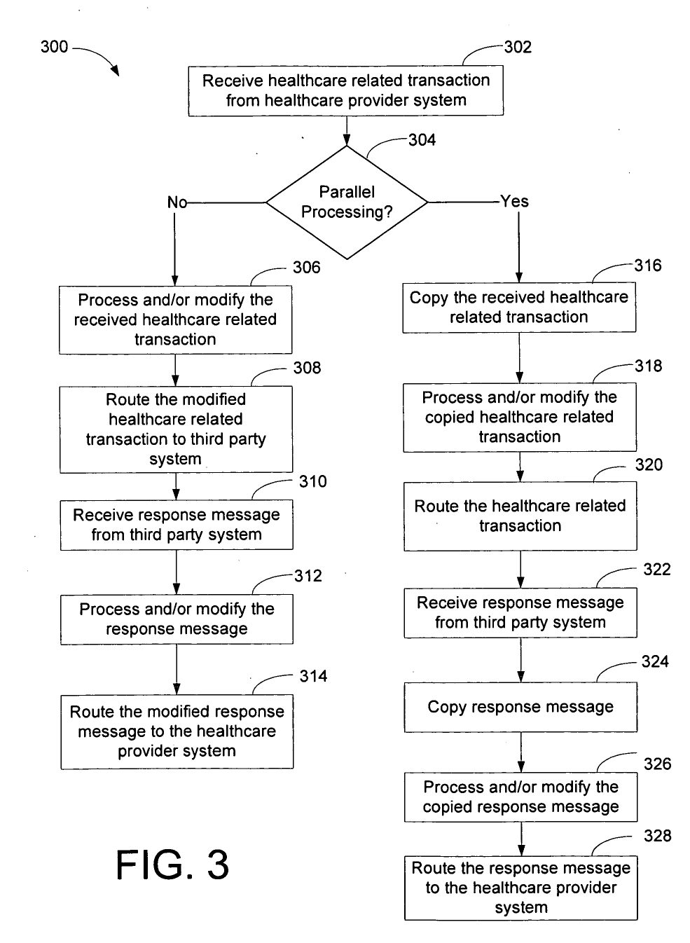

Once the healthcare related transaction has been received by the switch provider, the switch provider may then parse the healthcare related transaction to review, edit, or modify data contained in the transaction and/or perform a value-add service or function based on the data contained in the transaction (e.g., obtain information pertaining to a drug of a prescription or patient eligibility information to obtain new cardholder IDs to be associated with the patient, etc.). For example, such value-add services may include verifying that the dosage indicated in an electronic script submitted to a pharmacy from the healthcare provider's office is acceptable. Other value-add services may include providing healthcare provider offices with printable items associated with electronic prescription transactions and/or electronic patient eligibility transactions. Such printable items may include electronic receipts or confirmation messages indicating that a script submitted by the healthcare provider has been accepted and/or that a healthcare provider may locally dispense the prescribed drug. Other printable items associated with electronic prescription transactions and/or electronic patient eligibility transactions may include vouchers for prescription drug samples or coupons for prescription and/or over the counter drugs that may be provided to patients at the healthcare provider's office for later redemption at a pharmacy. Other value-add services may also be implemented through example embodiments of the invention. In another example embodiment of the invention, the switch provider may copy the healthcare related transaction for parallel processing discussed in further detail below with reference to FIG. 3.

Once the switch provider has processed the healthcare related transaction, the healthcare related transaction is routed to a third party system. A response message pertaining to the modified transaction data and/or value-add service performed may be transmitted from the third party system to the switch provider. The switch provider may then modify the content of the response message before sending the response message to the healthcare provider system that initiated the healthcare related transaction, or alternatively, the switch provider may route the response message to the healthcare provider system without modification. In some example embodiments of the invention, the switch provider (or third party system) provides modifications to the content of the response message. These modifications may include adding medication or diagnosis guides, promotional information, and/or MTM information (e.g., cancer-support group enrollment information, quit smoking group enrollment information, weight loss group enrollment information, drug registration information, etc.) to the response message, such as information pertaining to a new drug therapy to educate the patient about various aspects of the drug therapy, offers for MTM consultation for the prescribing healthcare provider, patient, or both, contact information for MTM information sources, etc.

In other example embodiments of the invention, messaging from the third party system (e.g., pharmacy) to the switch provider may include refill requests to be delivered to a patient's healthcare provider. The refill request information contained in such messages may inform a healthcare provider of a previous prescription for one of the healthcare provider's patients and inquire as to the possibility of refilling the prescription. Such messaging may be provided from the pharmacy to the healthcare provider avoiding the need for the patient to contact and/or return to the healthcare provider's facilities for a prescription refill.

Embodiments of the invention allow a switch provider, such as the switch offered by RelayHealth®, to offer centralized healthcare related transaction processing for a variety of healthcare providers, electronic prescription vendors, pharmacies, health plans, and/or the like. Embodiments of the invention may also provide an independent review of the generated healthcare related transaction that is conducted before (or during) the delivery or performance of healthcare related services (e.g., during the routing of an electronic prescription transaction to a pharmacy).

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention are described below with reference to block diagrams and flowchart illustrations of systems, methods, apparatuses and computer program products. It will be understood that each block of the block diagrams and flowchart illustrations, and combinations of blocks in the block diagrams and flowchart illustrations, respectively, can be implemented manually and/or by computer program instructions. With respect to computer program instructions, they may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational elements or steps to be performed on the computer or other programmable apparatus to produce a computer-implemented process such that the instructions that execute on the computer or other programmable apparatus provide elements or steps for implementing one or more functions specified in the flowchart block or blocks.

Accordingly, blocks of the block diagrams and flowchart illustrations may support combinations of means for performing the specified functions, combinations of elements or steps for performing the specified functions, and program instruction means for performing the specified functions. It will also be understood that each block of the block diagrams and flowchart illustrations, and combinations of blocks in the block diagrams and flowchart illustrations, can be implemented manually or by special purpose hardware-based computer systems that perform the specified functions, elements or steps, or combinations of special purpose hardware and computer instructions.

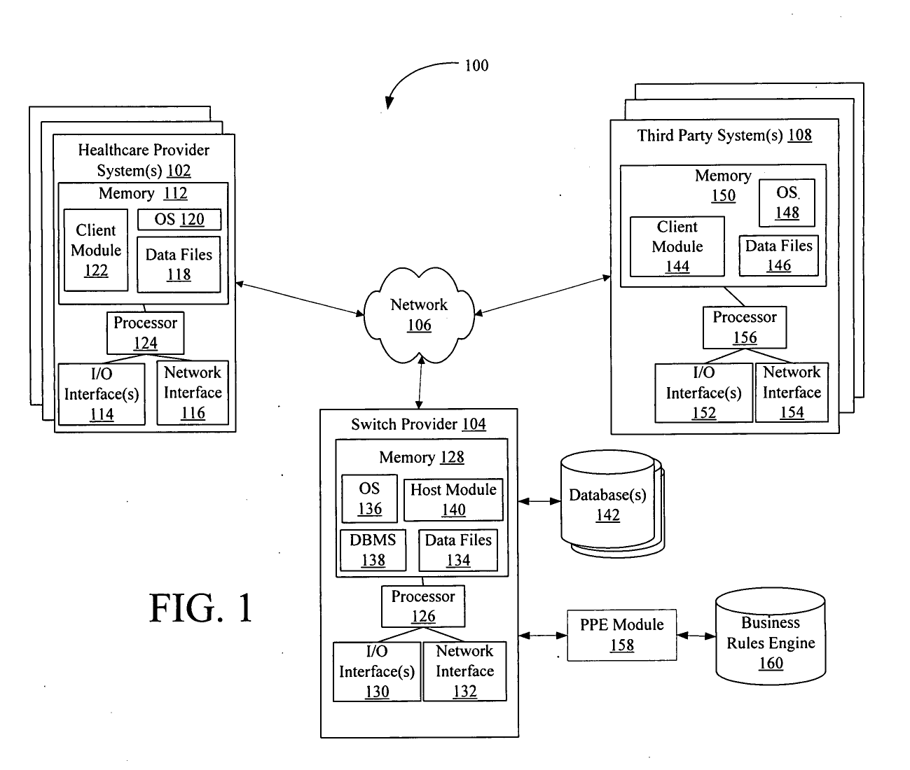

According to an example embodiment of the invention, there may be a system and method for processing, modifying, and/or performing a clinical, administrative and/or financial value-add service to transactions. FIG. 1 shows a healthcare related transaction system for the routing of electronic healthcare related transactions in accordance with an example embodiment of the invention. The overall healthcare related transaction system 100 of FIG. 1 may include healthcare provider systems 102 (e.g., a physician's practice management system, hospital or clinic computer systems such as clinical, practice management, scheduling and/or e-prescribing systems, and/or the like), one or more switch providers 104, and one or more third party systems 108 (e.g., pharmacy point of service devices, labs, other healthcare provider systems, pharmacy benefits managers (PBMs), health plan administrators, disease management entities, drug manufacturers, other vendors and/or business associates of healthcare service providers, government and/or non-government entities providing clinical, financial, and/or administrative services, and/or the like). Each healthcare provider system 102, switch provider 104, and third party system 108 may be configured for accessing and reading associated computer-readable media having stored thereon data and/or computer-executable instructions for implementing the various methods in accordance with example embodiments of the invention. Generally, network devices and systems, including the one or more healthcare provider systems 102, switch providers 104, and third party systems 108 have hardware and/or software for transmitting and receiving data and/or computer-executable instructions over a communications link and a memory for storing data and/or computer-executable instructions. These network devices and systems may also include a processor for processing data and executing computer-executable instructions, as well as other internal and peripheral components that are well known in the art. As used herein, the term “computer-readable medium” describes any form of memory device.

As shown in FIG. 1, the healthcare provider system 102, switch provider 104, and third party system 108 may be in communication with each other via a network such as network 106, which, as described below, can include one or more separate or shared private and public networks, including the Internet or a publicly switched telephone network. Each of these components—the healthcare provider system 102, the switch provider 104, the third party system 108, and the network 106—will now be discussed in further detail.

As shown in FIG. 1, the healthcare provider system 102 may comprise any processor-driven device, such as, but not limited to, a server computer, a mainframe computer, one or more networked computers, a desktop computer, a personal computer, a laptop computer, a mobile computer, a handheld portable computer, a digital assistant, a personal digital assistant, a digital tablet, or any other processor-based device. The healthcare provider system 102 may be associated with a hospital, physician's office, clinic, or another type of healthcare provider. In addition to having a processor 124, the healthcare provider system 102 may further include a memory 112, input/output (“I/O”) interface(s) 114 and a network interface 116. The memory 112 may store data files 118 and various program modules, such as an operating system (“OS”) 120 and a client module 122. The memory 112 may be any computer-readable medium, coupled to the processor 124, such as RAM, ROM, and/or a removable storage device for storing data files 118 and a database management system (“DBMS”) to facilitate management of data files 118 and other data stored in the memory 112 and/or stored in separate databases. The OS 120 may be, but is not limited to, Microsoft Windows®, Apple OSX™, Unix, or a mainframe operating system. The client module 122 may include an Internet browser or other software, including a dedicated program, for interacting with the switch provider 104 and/or third party system 108 via a web portal provided by (or accessible through) the switch provider 104 or via other communication means. For example, a user such as a physician or another prescribing entity or their agent (e.g., nurse, assistant, office clerk, etc.) may utilize the client module 122 to communicate with the switch provider 104, such as when submitting healthcare related transactions (e.g., prescription transactions) to be delivered to third party systems 108 and/or when receiving or retrieving response messages or supplemental information corresponding to previously submitted healthcare related transactions.

Still referring to the healthcare provider system 102, the I/O interface(s) 114 may facilitate communication between the processor 124 and various I/O devices, such as a keyboard, mouse, printer, microphone, speaker, monitor, bar code readers/scanners, radio frequency identification (RFID) readers, and/or the like. The network interface 116 may take any of a number of forms, such as a network interface card, a modem, a wireless network card, and/or the like. Other components not discussed herein may also be incorporated into the healthcare provider system 102 according to some example embodiments of the invention. Moreover, it will be appreciated that while the healthcare provider system 102 has been illustrated as a single computer or processor, the healthcare provider system 102 may be comprised of a group of computers or processors, according to an example embodiment of the invention.

The switch provider 104 (also referred to as the “switch”) may include any processor-driven device that is configured for receiving, processing, and/or fulfilling healthcare related transactions from the healthcare provider system 102 or from a third party system 108. Such processor-driven device may be a server computer, a mainframe computer, one or more networked computers, a desktop computer, a personal computer, a laptop computer, a mobile computer, a handheld portable computer, a digital assistant, a personal digital assistant, a digital tablet, or any other processor-based device. In some example embodiments of the invention, the switch provider 104 may be referred to as, or incorporated into, a service provider computer. As described herein, the switch provider 104 may comprise computer-executable instruction for implementing one or more methods described herein, including communicating with a PPE module 158 to providing value-add services to healthcare related transactions received by the switch provider 104. According to an example embodiment of the invention, the switch provider 104 may comprise, but is not limited, to one or more “switches” or “switch providers” performing routing and processing of various requests and/or transactions between or among physician systems 102, third party systems 108, and/or other switch providers 104.

The switch provider 104 may include a processor 126, a memory 128, input/output (“I/O”) interface(s) 130, and a network interface 132. The memory 128 may store data files 134 and various program modules, such as an operating system (“OS”) 136, a database management system (“DBMS”) 138, and a host module 140.

The OS 136 may be, but is not limited to, Microsoft Windows®, Apple OSX™, Unix, or a mainframe operating system. The memory 128 may be any computer-readable medium, coupled to the processor 126, such as RAM, ROM, and/or a removable storage device for storing data files 134 and a database management system (“DBMS”) 138 to facilitate management of data files 134 and other data stored in the memory 128 and/or stored in one or more databases 142 and/or business rules engine 160.

According to an embodiment of the invention, the data files 134 may store healthcare related transaction records associated with healthcare related transactions received from the physician system 102. The data files 134 may also store routing tables for determining the destination of communications received from the physician systems 102 or third party systems 108. For example, these routing tables may determine that particular submissions from a physician system 102 computer are associated with certain third party systems 108 and are to be routed to such third party systems 108 (or alternatively submissions from third party system 108 computers are to be routed to physician system 102 computers). In example embodiments of the invention, the host module 140 may initiate, receive, process, and/or respond to requests from a client module 122 of a physician system 102 computer, and may further initiate, receive, process, and/or respond to requests from a client modules 144 of the third party system 108 computer. For example, the host module 140 may provide web portal functionality accessible by the client module 122 of the physician system 102.

In some example embodiments of the invention, a web portal interface may be operative with or otherwise associated with the switch provider 104. In particular, the web portal interface may allow for a physician system 102 or another computer to access the switch provider 104. For example, a physician system 102 may access the web portal interface via a network such as network 106, which may include the Internet. According to an example embodiment of the invention, the physician system 102 or another computer may access the web portal interface via a network such as network 106 to submit a healthcare related transaction for value-add processing, access a particular value-add service, and/or retrieve a processed healthcare related transaction. For example, a physician system may access the web portal interface to locate previously submitted electronic prescriptions, retrieve coupon information, MTM information, and/or other information associated with a prescription transaction, or access a message received from a third party system relating to a prescription (e.g., a refill request), etc.

In some example embodiments of the invention, the web portal interface may be provided by a separate processor-based system that is distinct from the switch provider 104. By way of example, the web portal interface may be provided by a web server that is in communication with network 106 and the switch provider 104. According to another example embodiment of the invention, it will be appreciated that the web portal interface may be incorporated into the switch provider 104. The web portal interface may be associated with one or more universal resource locators (URLs) or website addresses, according to an example embodiment of the invention.

In some embodiments of the invention, the switch provider 104 may be comprised of two or more distinct switch providers that are in communication with each other. A first switch provider may be operative with the physician system 102 and coupon administrator processor 106 while a second switch provider may be operative with other physician systems 102 and third party systems 108. However, the first switch provider may have a data processing arrangement with the second switch provider. Under the data processing agreement, the first switch provider may be permitted to utilize or offer value-add services of the second switch provider, including the value-add services accessible through the switch provider 104 and/or the web portal interface also described herein. Accordingly, the value-add services accessible through the second switch provider may be available to the physician system 102 via the first and/or the second switch provider.

As also illustrated in FIG. 1, the switch provider 104 may include or otherwise be in communication with the PPE module 158. The PPE module 158 may include or be in communication with a business rules engine 160, for providing value-add services to the healthcare related transactions received by the switch provider 104. In some example embodiments of the invention the business rules engine 160 may be located in or considered part of the data storage device 142.

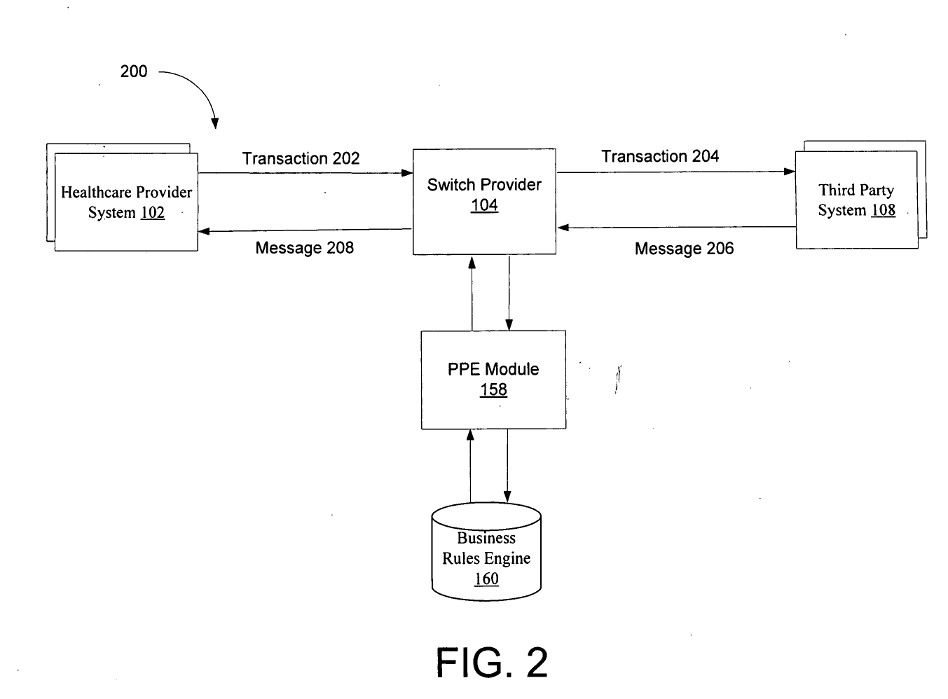

In an example embodiment of the invention, a Pre and Post Edit (PPE) module 140 provides the web portal functionality accessible by the client module 122 of the healthcare provider system 102 and/or accessible by the third party system 108. In an example embodiment of the invention, the PPE module 158 receives, processes, and responds to healthcare related requests from the client module 122 of the healthcare provider system 102, and further receives, processes, and responds to requests and claims received from the client module 144 of the third party system 108. In an example embodiment of the invention, the PPE module 158 includes a back-end analytic, editing, messaging, and reporting system for transactions between prescribing entities and pharmacies. The PPE module 158 may be in communication with, but separate from, the switch provider 104, or alternatively, the PPE module 158 may be incorporated into the switch provider 104. A more detailed discussion of the functionality of the PPE module 158 is included below in the discussion of FIGS. 2 and 3.

The switch provider 104 receives, processes, and responds to healthcare related transactions from the client module 122 of the healthcare provider system 102, and further receives, processes, and responds to requests received from the third party system 108. As described herein, the switch provider 104 may comprise computer-executable instructions for communicate with the PPE module 158 to implement one or more methods described herein, including processing, modifying, and/or performing a clinical, administrative, and/or financial value-add service to healthcare related transactions. The switch provider 104 and/or the PPE module 158 may likewise be operative to communicate and/or store various healthcare related data including prescription data, patient data, drug formulary information, etc. in a database 142, which may be a distinct database or a database shared with the healthcare provider system 102, and/or the third party system 108.

In the example embodiment of the invention shown in FIG. 1, the PPE module 158 includes, or is in communication with, a business rules engine 160. The business rules engine 160 may store the logic for implementing the value-add services to healthcare related transactions. In an example embodiment of the invention, the business rules engine 160 in communication with the PPE module 158 may include additional data to facilitate healthcare related transaction processing. In an example embodiment of the invention, the healthcare related transaction may be an electronic prescription transaction and the business rules engine 160 may include various data elements that may be used in the processing of the electronic prescription transaction including: patient rosters and/or patient pharmacy benefit cardholder IDs, preferred pharmacy lists, a “Virtual Sample Formulary” data set inclusive of drug information, etc. In some example embodiments of the invention, the business rules engine 160 may be included as part of database 142, in other embodiments the business rules engine is separate from the database 142.

While the PPE module 158 may be represented in FIG. 1 as a single module (or application), it may actually be two or more modules (or applications) implemented on respective computers. For example, a first module may be directed towards providing a value-add service to a submission from the healthcare provider system 102 to the switch provider 104. Likewise, a second module may be directed towards providing a value-add service to a response from the third party system 108 to the switch provider 104. A more detailed discussion of the functionality of the PPE module 158 is included below in the discussion of FIGS. 2-3.

The switch provider 104 and/or the PPE module 158 may be operative to store transaction data, patient data, and/or a other information useful for providing one or more value-add services in database(s) 142, which may include a distinct database and/or a database shared with the healthcare provider systems 102 and/or the third party system 108. In some example embodiments of the invention transaction data, patient data, and/or a other information useful for providing one or more value-add services may be stored in the business rules engine 160. In example embodiments of the invention, the database 142 and/or business rules engine 160 may be one or more databases operable for storing information that supports the processing of value-add services applicable to healthcare related transactions submitted by a healthcare provider system 102 or responses to such transactions generated by third party systems 108, according to an example embodiment of the invention. In an example embodiment of the invention, the database(s) 142 in communication with the PPE module 158 and/or switch provider 104 may include additional data to facilitate value-add service processing including: patient rosters and/or patient pharmacy benefit cardholder IDs, preferred pharmacy lists, drug formulary data, etc. The database(s) 142 may also include other data that may be useful in value-add service processing.

The third party system 108 may include any processor-driven device that is configured for receiving and processing healthcare related transactions received from the switch provider 104. According to example embodiments of the invention, the third party system 108 may be any processor-driven device, such as, but not limited to, a server computer, a mainframe computer, one or more networked computers, a desktop computer, a personal computer, a laptop computer, a mobile computer, a handheld portable computer, a digital assistant, a personal digital assistant, a digital tablet, or any other processor-based device.

The third party system 108 may include a processor 156, a memory 150, input/output (“I/O”) interface(s) 152, and a network interface 154. The memory 150 may store data files 146 and various program modules, such as an operating system (“OS”) 148, and the client module 144. The memory 150 may be any computer-readable medium, coupled to the processor 156, such as RAM, ROM, and/or a removable storage device for storing data files 146 and a database management system (“DBMS”) to facilitate management of data files 146 and other data stored in the memory 150 and/or stored in separate databases. The OS 148 may be, but is not limited to, Microsoft Windows®, Apple OSX™, Unix, or a mainframe operating system. The client module 144 may receive, process, and respond to requests received from the switch processor 104.

Still referring to the third party system 108, the I/O interface(s) 152 may facilitate communication between the processor 156 and various I/O devices, such as a keyboard, mouse, printer, microphone, speaker, monitor, bar code readers/scanners, RFID readers, and/or the like. The network interface 154 may take any of a number of forms, such as a network interface card, a modem, a wireless network card, and/or the like. It will be appreciated that while the third party system 108 has been illustrated as a single computer or processor, the third party system 108 may be comprised of a group of computers or processors, according to an example embodiment of the invention.

In FIG. 1, a healthcare provider system 102, switch provider 104, and third party systems 108 may be in communication with each other via one or more networks 106. The one or more networks 106 may include any telecommunication and/or data network, whether public, private, or a combination thereof, including a public switched telephone network (PSTN), a cellular network, a local area network, a wide area network, an intranet, an internet, the Internet, intermediate hand-held data transfer devices, and/or any combination thereof and may be wired and/or wireless. The one or more networks 106 may also allow for real-time, off-line, and/or batch transactions to be transmitted between or among the healthcare provider system 102, the switch provider 104, and the third party system 108. Due to network connectivity, various methodologies as described herein may be practiced in the context of distributed computing environments.

Generally, each of the memories and data storage devices, such as the memories 112, 128, 150, the database 142, business rules engine 160 and/or any other memory and data storage device, can store data and information for subsequent retrieval. In this manner, the system 100 can store various received or collected information in memory or a database associated with one or more healthcare provider system 102, switch providers 104, and/or third party systems 108. The memories and databases can be in communication with each other and/or other databases, such as a centralized database, or other types of data storage devices. In some example embodiments of the invention, when needed, data or information stored in a memory or database may be transmitted to a centralized database capable of receiving data, information, or data records from more than one database or other data storage devices. In other embodiments, the databases shown can be integrated or distributed into any number of databases or other data storage devices. In one example embodiment, for security, the switch provider 104 and/or PPE module 158 (or any other entity) may have a dedicated connection to the database 142 or business rules engine 160; though, in other embodiments, the switch provider 104, PPE module 158, or another entity may communicate with the database 142 or business rules engine 160 via a network such as network 106.

Suitable processors, such as the processors 124, 126, 156 of the healthcare provider system 102, switch provider 104, and/or third party system 108, respectively, may comprise a microprocessor, an application-specific integrated circuit (ASIC), and/or a state machine. Example processors can be those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer processor, including a router, private or public network, or other transmission device or channel, both wired and wireless. The instructions may comprise code from any computer-programming language, including, for example, C, C++, C#, Visual Basic, Java, Python, Perl, and JavaScript. Furthermore, any of the processors may operate any operating system capable of supporting locally executed applications, client-server based applications, and/or browser or browser-enabled applications.

The system 100 shown in and described with respect to FIG. 1 is provided by way of example only. Numerous other operating environments, system architectures, and/or device configurations are possible in various embodiments of the invention. Other system embodiments can include fewer or greater numbers of components and may incorporate some or all of the functionality described with respect to the system components shown in FIG. 1. For instance, in one example embodiment, the switch provider 104 (or the healthcare provider system 102/third party system 108) may be implemented as a specialized processing machine that includes hardware and/or software for performing the methods described herein. In addition, the processor and/or processing capabilities of the switch provider 104 and/or the PPE module 158, may be implemented as part of the healthcare provider system 102, the third party system 108, or any combination or portion thereof. Accordingly, embodiments of the invention should not be construed as being limited to any particular operating environment, system architecture, or device configuration.

FIG. 2 shows a data flow 200 of the data transmitted between the entities of the healthcare related transaction system in accordance with an example embodiment of the invention. As shown in FIG. 2, a healthcare related transaction is generated at the healthcare provider system 102 and sent to the PPE module 158 of the switch provider 104 as transaction 202. In an alternative embodiment of the invention not shown in FIG. 2, the healthcare related transaction may have been generated and submitted to the PPE module from a third party system 108. In example embodiments of the invention, the transaction standard for the healthcare related transaction may be one of NCPDP SCRIPT, ANSI X12, HL7, or similar transaction standards. Alternatively, the transactions and/or the format of the transactions may be proprietary.

In example embodiments of the invention, data that may be included in the healthcare related transaction may include one or more of the following categories of information:

Prescriber information
a. Name of the prescriber
b. Prescriber identifier for a physician or healthcare provider

Pharmacy information
a. Identifier of the pharmacy submitting the claim request

Patient information
a. Insurance or coverage information
b. Name, address, date of birth
c. Patient Diagnosis/Condition

Prescription information:
a. Identification of the prescribed drug or product (e.g., National Drug Code (NDC))
b. Prescription number
c. Quantity and/or days supply of the prescribed drug or product
d. Pricing information for the prescribed drug or product
e. Date prescription written.

It will be also appreciated that while some example information has been illustrated for the example healthcare related transaction, alternate or additional information may also be included without departing from example embodiments of the invention. For example, other healthcare related transactions may include several categories (or types) of data in the healthcare transaction that may be parsed and/or utilized by the PPE module 158 in communication with the switch provider 104, such as lab data, electronic medical records, patient eligibility data, script history, drug information, patient membership information, etc. In other example embodiments of the invention, healthcare transactions may include medical service identification information including the International Classification of Diseases (ICD9) and/or International Classification of Diseases Clinical Modification (ICD9CM) codes or current procedural termination (CPT) codes information.

Once the transaction 202 is received at the switch provider 104, the PPE module 158 may pass the transaction 204 to the third party system 108 specified by data included in the healthcare related transaction 202, or alternatively, provided by the PPE module 158. In some example embodiments of the invention, the PPE module 158 may process, modify, and/or perform clinical, administrative and/or financial value-add services to the submitted transaction 202, or determine the third party system 108 that should receive the transaction 204. According to example embodiments of the invention, such value-add services that may be applicable to transaction 202 may include verifying the dosage indicated in an electronic script submitted to a third party system 108 (e.g., pharmacy) from the healthcare provider system 102. Other value-add services may also be implemented through example embodiments of the invention.

Once the third party system 108 receives transaction 204 from the switch provider 104, the third party system 108 may perform additional clinical, administrative and/or financial value-add services to the transaction 204, and/or create a response message 206 to be sent to the PPE module 158. Such value-add services provided by the third party system may include those described above as well as other value-add services discussed herein.

The response message 206 may be an acknowledgement of receipt of transaction 204, and/or may contain results (or report) from the third party system's 108 processing of transaction 204. Once received, the PPE module 158 may simply route the response message 206 to the corresponding healthcare provider system 102, or the PPE module 158 may perform a variety of edits such as clinical, administrative and/or financial value-add services to the response message 206. Such value-add services that may be applied to the response message may include those value-add services discussed above with reference to transaction 202, as well as other value-added services. For example, value-add services that may be applied to the response message 206 may include providing healthcare provider systems 102 with printable items associated with electronic prescription transactions and/or electronic patient eligibility transactions. Such printable items may include electronic receipts or confirmation messages indicating that a script submitted by the healthcare provider has been accepted and/or that a healthcare provider may locally dispense the prescribed drug. Other printable items associated with electronic prescription transactions and/or electronic patient eligibility transactions may include vouchers for prescription drug samples or coupons for prescription and/or over the counter drugs that may be provided to patients at the healthcare provider's office for later redemption at a pharmacy.

Other example value-add services include adding MTM information to the response message, such as information pertaining to a new drug therapy to educate the patient about various aspects of the drug therapy, offers for MTM consultation for the prescribing healthcare provider, patient, or both, contact information for MTM information sources, etc. In other example embodiments of the invention, messaging from the third party system 108 (e.g., pharmacy) to the switch provider 104 may include refill requests to be delivered to a patient's healthcare provider system 102. The refill request information contained in such messages may inform a healthcare provider system 102 of a previous prescription for one of the healthcare provider's patients and inquire as to the possibility of refilling the prescription. Such messaging may be provided from the pharmacy to the healthcare provider avoiding the need for the patient to contact and/or return to the healthcare provider's facilities to obtain a prescription refill. Once the edits (if any) provided by the PPE module 158 on the response message 206 are completed, message 208 may be routed to the appropriate healthcare provider system 102. The PPE module 158 may be in communication with, but separate from, the switch provider 104, or alternatively, the PPE module 158 may be incorporated into the switch provider 104.

As another example value-add service provided by some embodiments of the invention, the PPE module 158 may be in communication with a claim processing entity or claim processing module through the switch provider 104 to obtain information (e.g., updated financial related information) that may be used in the processing of the healthcare related transactions. In some other embodiments of the invention, the PPE module 158 may be in communication with a claim processing entity or claim processing module through the switch provider 104 to communicate healthcare related transaction data to the claim processing entity or claim processing module for additional processing. In one example embodiment of the invention, dosage information (and/or other prescription information) from an electronic prescription may be passed from the PPE module 158 to the claim processing module to allow the claim processing module to confirm the proper adjudication of a claim associated with the submitted electronic prescription. PPE module 158 In alternative embodiments of the invention, it is appreciated that one or more transmissions of a healthcare related transaction or message may bypass the switch provider 104 (and/or the PPE module 158) and communicate with the intended entity (e.g., healthcare provider system 102 or third party system 108) directly.

The example process elements of FIG. 2 are shown by way of example, and other process and flow embodiments can have fewer or greater numbers of elements, and such elements can be arranged in alternative configurations in accordance with other embodiments of the invention. Thus, many variations of the data flow described above with reference to FIG. 2 will be available in accordance with various example embodiments of the invention.

FIG. 3 shows a flowchart 300 for “pre” and “post” edit (PPE) processing of electronic healthcare related transactions in accordance with an example embodiment of the invention. As shown in FIG. 3, the process begins in block 302 with a healthcare related transaction being received by the PPE module from a healthcare provider system or third party system. Next, in block 304 the PPE module determines if the transaction is to undergo parallel processing or if the transaction itself is to be process for the value-add service. In an example embodiment of the invention, the outcome of this determination is dependent on the service to be provided to the healthcare related transaction.

If it is determined in block 304 that the value-add service to be performed does not require parallel processing then block 306 is invoked to perform “pre” edit processing, where the PPE module parses and/or reviews the content of the healthcare related transaction and may modify the content according the preset rules. The modification of the transaction content may be to correct an error detected in the transaction or provide another value-add service (e.g., amending the transaction data with additional information such as information pertaining to the prescribed drug, advising the prescribing entity regarding the routing information to send the transaction to a preferred system such as a preferred pharmacy, subtracting or reformatting transaction content to be compatible and/or acceptable to a particular third party system, etc.). Other value-add services that may be performed include verifying the dosage indicated in an electronic script submitted to a third party system (e.g., pharmacy) from the healthcare provider system. Other value-add services may also be implemented through example embodiments of the invention. Once processing and/or modification of healthcare related transaction content has been completed, block 306 is invoked where the modified transaction is routed to a third party system.

In an alternative embodiment of the invention (not shown in FIG. 3), a message pertaining to the processing and/or modification of the transaction may be sent to the transaction submitting entity (healthcare provider system, different third party entity, etc.). In one alternative embodiment of the invention, the modified (or processed) transaction may not be routed to the third party until the healthcare provider system is sent a message and the healthcare provider system responds to the message with instructions (or approval) to proceed with routing the transaction to the third party system.

As shown in FIG. 3, block 310 occurs when an acknowledgement or response message pertaining to the transaction is received from a third party entity in response to the routing of the modified (or processed) transaction to that third party entity. The message may pertain to a clinical, administrative, and/or financial aspect of processing the transaction. In example embodiments of the invention, the response message standards supported may include: NCPDP SCRIPT, ANSI X12, HL7, etc. Alternatively, the response message and/or the format of the response message may be proprietary.

Next, block 312 is invoked to perform “post” edit processing, where the PPE module parses and/or reviews the content of the response message and may modify the content according the preset rules. The modification of the response message content may be to correct an error detected in the response message or provide another value-add service that is clinical, administrative and/or financial in nature. For instance, the response message data may be amended with additional information relevant to the response message content (e.g., amending the response message to include a disease management enrollment message for a qualifying and/or sponsored patient). Other examples of value-add services that may be applied to the response message may include those value-add services discussed above with reference to block 306, as well as other value-added services. For example, value-add services that may be applied to the response message may include providing healthcare provider systems with printable items associated with electronic prescription transactions and/or electronic patient eligibility transactions. Such printable items may include electronic receipts or confirmation messages indicating that a script submitted by the healthcare provider has been accepted and/or that a healthcare provider may locally dispense the prescribed drug. Other printable items associated with electronic prescription transactions and/or electronic patient eligibility transactions may include vouchers for prescription drug samples or coupons for prescription and/or over the counter drugs that may be provided to patients at the healthcare provider's office for later redemption at a pharmacy.

Other example value-add services that may be applied to the response message may include adding MTM information to the response message, such as information pertaining to a new drug therapy to educate the patient about various aspects of the drug therapy, offers for MTM consultation for the prescribing healthcare provider, patient, or both, contact information for MTM information sources, etc. In other example embodiments of the invention, messaging from the third party system 108 (e.g., pharmacy) to the switch provider 104 may include refill requests to be delivered to a patient's healthcare provider system 102. The refill request information contained in such messages may inform a healthcare provider system 102 of a previous prescription for one of the healthcare provider's patients and inquire as to the possibility of refilling the prescription. Such messaging may be provided from the pharmacy to the healthcare provider avoiding the need for the patient to contact and/or return to the healthcare provider's facilities to obtain a prescription refill. Once processing and/or modification of the response message has been completed, block 314 is invoked where the modified transaction is routed to a healthcare provider system.

As shown in FIG. 3, if it is determined in block 304 that the value-add service to be performed does require parallel processing then block 316 is invoked where a copy of at least a portion of the transaction data is made for processing. The copy of the transaction data may be stored for future use. In block 318, value-add services and/or other “pre” edit processing may be performed using the copied transaction data. The various types of value-add services that may be performed are the same as those described above with reference to block 306.

Next, block 320 is invoked, where a message pertaining to the value-add service performed or other processing of the copied transaction data may be sent to the submitting healthcare provider system or third party system. The message may pertain to a clinical, administrative, and/or financial value-add service performed using the copied transaction data. In example embodiments of the invention, the response message standards supported may include: NCPDP SCRIPT, ANSI X12, HL7, etc. Alternatively, the transactions and/or the format of the transactions may be proprietary. In an alternative embodiment of the invention, block 320 may occur before or concurrently with blocks 316 and 318. In an alternative embodiment of the invention not shown in FIG. 3, the transaction may be routed to the third party only after the healthcare provider system is sent a message pertaining to the processing of the transaction data and the healthcare provider system responds to the message with instructions (or approval) to proceed with routing the transaction to the third party.

In response to the routing of the transaction to the third party entity, the third party entity may transmit an acknowledgement or response message pertaining to the processing of the transaction by that third party entity to be received by the PPE module in block 322 to eventually be provided to the transaction-originating entity (e.g., healthcare provider system, a separate third party entity, etc.) via the PPE module. The response message may pertain to a clinical, administrative, and/or financial aspect of processing the transaction. In example embodiments of the invention, the response message standards supported may include: NCPDP SCRIPT, ANSI X12, HL7, etc. Alternatively, the response messages and/or the format of the response messages may be proprietary.

Once the response message is received in block 322, block 324 is invoked where a copy of at least a portion of the response message data is made for processing. The copy of the response message data may be stored for future use. Next, block 326 is invoked to perform “post” edit processing, where the PPE module parses and/or reviews the content of the response message (e.g., the copied response message data) and may modify and/or process the data according the preset rules or value-add service logic. The modification and/or processing of the response message data may be to correct an error detected in the response message or provide another value-add service that is clinical, administrative and/or financial in nature. For instance, the response message data may be amended with additional information relevant to the response message content (e.g., amending the response message to include a disease management enrollment message for a qualifying and/or sponsored patient). Other types of value-add services that may be performed are the same as those described above with reference to block 312. Once processing and/or modification of response message has been completed, block 328 is invoked where the response message is routed to a third party system. In an alternative embodiment of the invention, block 328 may occur before or concurrently with blocks 324 and 326.

The example process elements of FIG. 3 are shown by way of example, and other process and flow embodiments can have fewer or greater numbers of elements, and such elements can be arranged in alternative configurations in accordance with other embodiments of the invention. Thus, many variations of the process described above with reference to FIG. 3 will be available in accordance with various example embodiments of the invention.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer implemented method comprising:
receiving, from a healthcare provider system, an electronic prescription transaction;
performing, by a switch provider processor, a value-add service to the electronic prescription transaction, wherein the value-add service creates a modified electronic prescription transaction; and
forwarding the modified electronic prescription transaction to a pharmacy system specified in the electronic prescription transaction.

2. The method of claim 1, further comprising:
prior to creating the modified electronic prescription transaction, creating a copy of the electronic prescription transaction; and
storing the copy of the electronic prescription transaction.

3. The method of claim 1, further comprising:
transmitting a response message to the healthcare provider system, wherein the response message is associated with the modified healthcare related transaction.

4. The method of claim 3, further comprising:
prior to forwarding the modified electronic prescription transaction to the pharmacy system, receiving an approval message from the healthcare provider system.

5. The method of claim 1, further comprising storing the modified electronic prescription transaction prior to forwarding the modified electronic prescription transaction to the pharmacy system.

6. The method of claim 1, wherein creating a modified electronic prescription transaction includes correcting an error detected in the electronic prescription transaction.

7. The method of claim 1, wherein creating a modified electronic prescription transaction includes amending the data contained in the electronic prescription transaction with routing information associated with the pharmacy system, wherein the pharmacy system is a preferred pharmacy system.

8. The method of claim 1, wherein creating a modified electronic prescription transaction includes amending the data contained in the electronic prescription transaction to include additional information pertaining to a prescribed drug identified in the electronic prescription transaction.

9. A system comprising:
a memory device; and
a processor in communication with the memory device, wherein the processor is configured to execute computer executable instructions to:
receive, from a healthcare provider system, an electronic prescription transaction;
perform a value-add service to the electronic prescription transaction, wherein the value-add service creates a modified electronic prescription transaction; and
forward the modified electronic prescription transaction to a pharmacy system specified in the electronic prescription transaction.

10. The system of claim 9, wherein the processor is further configured to execute instructions to:
create a copy of the electronic prescription transaction prior to processing; and
store the copy of the electronic prescription transaction in the memory device.

11. The system of claim 9, wherein the processor is further configured to execute instructions to:
transmit a response message to the healthcare provider system, wherein the response message is associated with the modified healthcare related transaction.

12. The system of claim 11, wherein the processor is further configured to execute instructions to:
receive an approval message from the healthcare provider system prior to forwarding the modified electronic prescription transaction to the pharmacy system.

13. The system of claim 9, wherein the processor is further configured to execute instructions to:
store the modified electronic prescription transaction prior to forwarding the modified electronic prescription transaction to the pharmacy system.

14. The system of claim 9, wherein the computer executable instructions to create a modified electronic prescription transaction include correcting an error detected in the electronic prescription transaction.

15. The system of claim 9, wherein the computer executable instructions to create a modified electronic prescription transaction include amending the data contained in the electronic prescription transaction with routing information associated with the pharmacy system, wherein the pharmacy system is a preferred pharmacy system.

16. The system of claim 9, wherein the computer executable instructions to create a modified electronic prescription transaction include amending the data contained in the electronic prescription transaction to include additional information pertaining to a prescribed drug identified in the electronic prescription transaction.

17. A system for comprising:
a memory device; and
a processor in communication with the memory device, wherein the processor is configured to execute computer executable instructions to:
receive, from a pharmacy system, a response to an electronic prescription transaction previously submitted by a healthcare provider system;
perform a value-add service to the response to the electronic prescription transaction, wherein the value-add service creates a modified response; and
forward the modified response to the healthcare provider system specified in the electronic prescription transaction.

18. The system of claim 17, wherein the processor is further configured to execute instructions to:
store the response in the memory device prior to creating a modified response.

19. The system of claim 17, wherein the computer executable instructions to create a modified response include amending the response to include additional information.

20. The system of claim 19, wherein the additional information is a disease management enrollment message.
